(19) United States
(12) Patent Application Publication
(10) Pub. No.: US 2018/0181963 A1
(43) Pub. Date: Jun. 28, 2018

(54) METHOD AND SYSTEM FOR PURCHASE PRECHECK

(71) Applicant: MasterCard International Incorporated, Purchase, NY (US)

(72) Inventors: Andrey Birukov, Scarsdale, NY (US); Henry M. Weinberger, New York, NY (US); Michael J. Cardamone, New Windsor, NY (US); Po Hu, Norwalk, CT (US); Heather Marie Kowalczyk, Oakland, NJ (US); Avyaktanand Tiwary, Gugaon (IN)

(21) Appl. No.: 15/389,637

(22) Filed: Dec. 23, 2016

(51) Int. Cl. G06Q 20/40; G06Q 20/38; G06Q 20/32

(52) U.S. Cl. CPC G06Q 20/40145; G06Q 20/382; G06Q 10/107; G06Q 20/405; G06Q 20/3274

(57) ABSTRACT

Methods, apparatus and systems, the method including receiving, by a processor of a consumer mobile device, a request from a user for a purchase pre-authorization; receiving, by a biometric input component of the consumer mobile device, biometric data that uniquely identifies the user; sending a representation of the biometric data to a pre-purchase authentication server; receiving, by the mobile device processor from the pre-purchase server, a message including a unique code, the unique code being associated with a payment card account of the user and valid to use to authorize future purchase transactions using the payment card account for a finite period of time and a specific amount of funds of the payment card account; and displaying, on a display screen component of the consumer mobile device in response to the request, the unique code.

### FIELD OF THE INVENTION

Exemplary embodiments described herein generally relate to providing a method and system for a purchase pre-authorization or pre-check for users conducting purchase transactions. In particular, in some embodiments a purchase pre-authorization system and method functions to provide a code to a user via a consumer mobile device that may be used to authorize future purchase transactions, where the code is valid for a specific period of time and a specific amount of funds.

### BACKGROUND

Payment card accounts such as credit card accounts, debit card accounts and pre-paid debit card accounts are widely used. In a retail store environment, a cardholder typically presents a plastic payment card, which may include a magnetic stripe and/or chip, at a point of sale (POS) device as payment for goods and/or services. The POS device at the merchant may read account information from the card via a wired or wireless communication protocol to initiate a payment card account transaction using information read from the card. In an on-line environment, a cardholder may use browser software running on a personal computer or a mobile device to access a merchant's online store webpage. After selecting goods for purchase and then opting to check out, the cardholder may be prompted to enter some payment card account information into a data entry portion of a user interface displayed on a display component of the user's computing device. In response, whether in-person or on-line, the merchant commences an authorization process to determine whether the payment card account is approved for use to complete the purchase transaction.

In some instances, a purchase transaction authorization process may result in a false positive (i.e., an erroneous decline of the payment device for the particular transaction). In these and other situations resulting in a decline of a transaction authorization, the merchant may lose an otherwise good customer because of an erroneous/false authorization process result.

Accordingly, a need exists for an efficient mechanism to authorize a payment card account for a purchase transaction in advance of the user commencing a purchase transaction.

### BRIEF DESCRIPTION OF THE DRAWINGS

Features and advantages of the exemplary embodiments, and the manner in which the same are accomplished, will become more readily apparent with reference to the following detailed description taken in conjunction with the accompanying drawings, in which:

FIG. 1 is a schematic diagram illustrating an example of a system including a purchase pre-authorization service, in accordance with some embodiments of the present disclosure;

FIG. 2 is a flow diagram of an example process flow, in accordance with some embodiments of the disclosure;

FIG. 3 is a flow diagram of an example process flow, in accordance with some embodiments of the disclosure;

FIG. 4 is an example of a mobile device, in accordance with some embodiments herein; and

FIG. 5 is an illustrative block diagram of a system, in accordance with some embodiments.

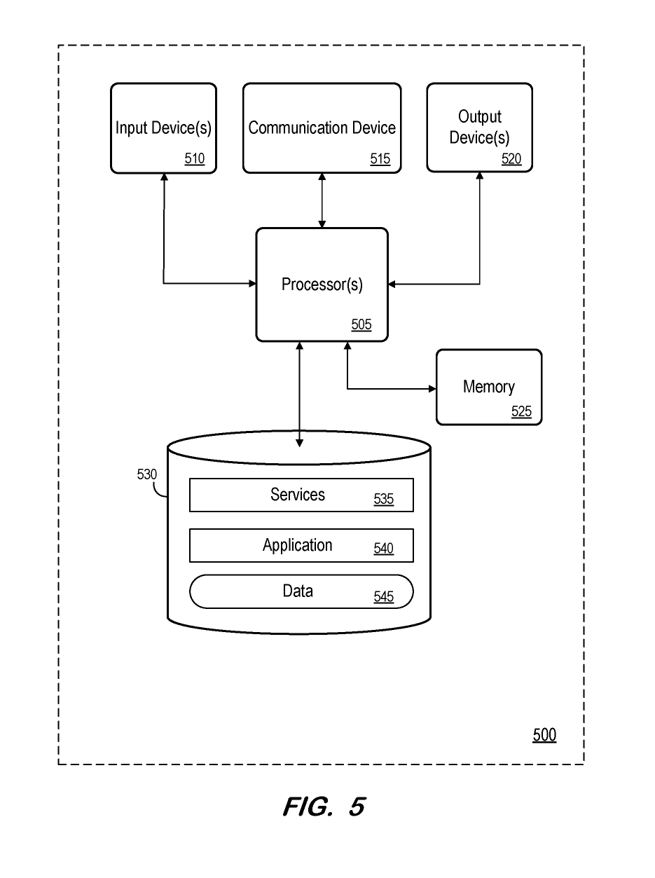

Throughout the drawings and the detailed description, unless otherwise described, the same drawing reference numerals will be understood to refer to the same elements, features, and/or structures. The relative size and/or depiction(s) of these elements may be exaggerated or adjusted for clarity, illustration, and/or convenience.

### DETAILED DESCRIPTION

In the following description, specific details are set forth in order to provide a thorough understanding of the various exemplary embodiments. It should be appreciated that various modifications to the embodiments will be readily apparent to those skilled in the art, and that principles defined herein may be applied to other embodiments and applications without departing from the spirit and scope of the invention. Moreover, in the following description, numerous details are set forth for the purpose of explanation. However, one of ordinary skill in the art should understand that embodiments may be practiced without the use of these specific details. In addition, in some cases well-known structures and/or processes are not shown or described in order not to obscure the description with unnecessary detail(s). Thus, the present disclosure is not intended to be limited to the embodiments shown, but is to be accorded the widest scope consistent with the principles and/or features disclosed herein.

In general, and for the purpose of introducing concepts of the present invention, one or more exemplary embodiments relate to a purchase pre-authorization service, application, or functionality for use by a consumer, cardholder, or user when shopping. The shopping experience may be online with, for example, a mobile device, or conducted by the consumer in a retail outlet. When the consumer wishes to finalize or consummate the purchase transaction, they initiate a checkout process with the merchant that triggers a payment card authorization process. The authorization process takes some time (e.g., a few seconds to a few minutes) and may, as highlighted in the example above, produce a false denial of the purchase transaction.

In some embodiments, a method and system are disclosed herein that provides an approved authorization for a purchase transaction involving a payment card account before a user or consumer starts a purchase transaction. As used herein, the pre-approved authorization may be referred to as a purchase pre-authorization. The purchase pre-authorization, in some embodiments, may be valid for a finite period and a specific amount of funds of the payment card account.

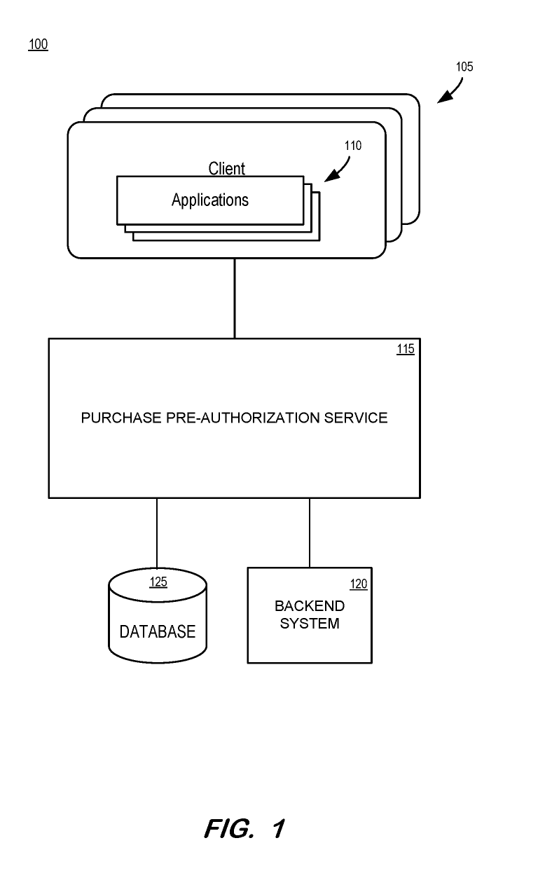

FIG. 1 is an illustrative block diagram of an architecture or system 100, in one example. Examples of some embodiments of the present disclosure are not limited to the particular architecture 100 shown in FIG. 1. System 100 includes one or more client devices 105 running one or more applications 110. Applications 110 may, in some embodiments, include a suite of different software applications having, at least to some extent, related functionality, similar user interfaces, and some ability to exchange data with each other. Applications 110 may include different, independent software applications in some embodiments. In some embodiments, one of the applications 110 may include functionality to obtain a purchase pre-authorization to be used in a purchase transaction. In some aspects herein, a purchase transaction can be for any product, service, and combinations thereof.

System 100 includes a purchase pre-authorization service or server 115. In some embodiments, a functionality or service for generating a purchase pre-authorization may be deployed as a cloud-based service, whereas in some other embodiments system 100 may include a client-server architecture. System 100 may encompass both scenarios. In the instance system 100 includes a server at 115, the devices at 105 may be client devices running applications as discussed above. In an instance system 100 includes a cloud-based server at 115, the devices at 105 may execute a browser that is used by a user to interface with service 115.

System 100 further includes a backend system that can generate, automatically, executable code or instructions to perform a process to create, edit, and maintain a database to organize, manage, and store data related to the purchase pre-authorization herein. In some aspects, the purchase pre-authorization may be represented by a data structure and instantiated to include a particular set of data. In particular, backend system 120 and database 125 may store and manage payment card accounts for one or more users registered with system 100. In some embodiments, a user may be registered with a system if the user's payment card account is managed by the system. In some aspects herein, a user may provide one or more types of their biometric information to the purchase pre-authorization service 115, wherein the biometric data for the user is associated, correlated, and otherwise coupled to the payment card account information for the user by the backend system 120 and database 125.

In some aspects, system 100 may be a secure system, where a number of security measures and techniques may be used to safeguard the integrity of the data processed, transferred, and stored by the system. In some embodiments, some or all of the data thereon may be encrypted. In particular, the payment card account information and the biometric information that can be associated with a user's payment card account information in database 125 may be implemented on secure server, using techniques now known and those that become known.

In one example, a client 105 executes an application 110 to present a purchase pre-authorization tool via a user interface (UI) to a user on a display of client 105. The user manipulates UI elements within the UI to indicate that they wish to register with a purchase pre-authorization service, where a server or service 115 embodying the purchase pre-authorization process operates, in cooperation with backend system 120 and database 125, to associate biometric information received from a user via their client device 105. Backend system 120 and database 125 may transform and configure the biometric information into a format compatible with database 125. In some instances, application(s) 110 may be created by or on behalf of the purchase pre-authorization service provider, vendor, or developer.

Database 125 may comprise any data source or sources that are or become known. Database 125 may comprise a relational database, a HTML document, an eXtensible Markup Language (XML) document, or any other data storage system storing structured and/or unstructured data files. The data of database 125 may be distributed among several data sources. Embodiments are not limited to any number or types of data sources. In some embodiments, database 125 may be referred to as a precheck database where it is used to implement at least some aspects of a purchase pre-authorization process disclosed herein.

Database 125 may implement an “in-memory” database, where a full database is stored in volatile (e.g., non-disk-based) memory (e.g., Random Access Memory). The full database may be persisted in and/or backed up to fixed disks (not shown). Embodiments herein are not limited to an in-memory implementation. For example, data may be stored in Random Access Memory (e.g., cache memory for storing recently-used data) and other forms of solid state memory and/or one or more fixed disks (e.g., persistent memory for storing their respective portions of the full database).

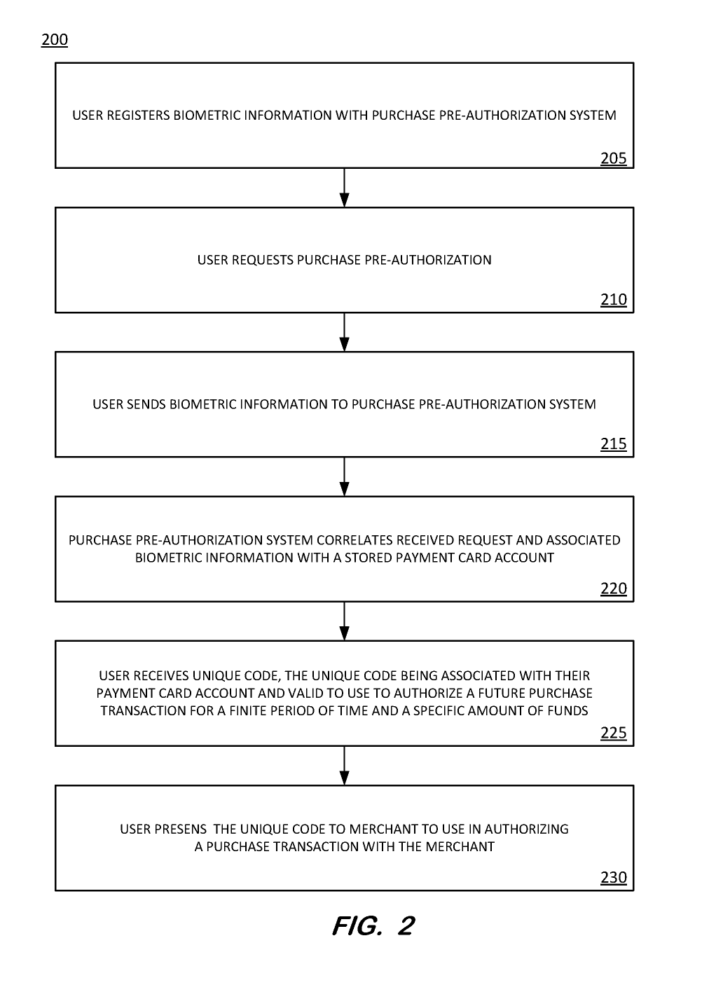

FIG. 2 is an illustrative flow diagram of a process, in accordance with an example embodiment herein. Process 200 may include a plurality of operations beginning before a user starts a purchase transaction with a merchant for goods and/or services. At operation 205, a user may register with a purchase pre-authorization service, application, or system that provides functionality of providing a purchase pre-authorization that can be used in a future purchase transaction to authorize the purchase transaction. As part of the registration process, the user may submit at least one type of personal biometric information to the purchase pre-authorization service. The biometric information may be, in some embodiments, a representation of the user's biometric information such as, for example, a hash value, as opposed to the (raw) biometric information. In this manner, the user's biometric information need not be stored by a purchase pre-authorization service herein.

At operation 210, the user, having been previously and successfully registered with the purchase pre-authorization service, application, tool, or functionality, may send a request or other indication that they wish to have a purchase pre-authorization to use in a purchase transaction. In some embodiments, there may be a substantial separation in time (e.g., a week or even a month) between operation 205 and operation 210. In some embodiments, the user makes the request for the purchase pre-authorization via an application or app executing on the user's mobile device (e.g., a smartphone or a tablet). In some respects, the request is made prior to the user interacting with a merchant to initiate a purchase transaction.

Continuing with process 200, operation 215 includes the user sending biometric information or a representation thereof to the purchase pre-authorization service. The biometric information provided at operation 215 may be seen as a component of the request of operation 210. Although illustrated as two operations in FIG. 2, operations 210 and 215 may be performed by a device, system, or other implementation such that the request for a purchase pre-authorization includes an indication the user wants a purchase pre-authorization and the user's biometric information.

At operation 220, the purchase pre-authorization service, system, and application operates to correlate or match the biometric information received at operation 215 with stored payment card account data of registered users of the purchase pre-authorization service, system, and application. In some embodiments, a query of a precheck database instance (e.g., database 125 in FIG. 1) is performed to determine the payment card account (if any) including biometric information that corresponds to the user's biometric information from operation 215. If a match is determined, then the purchase pre-authorization service, system, and application generates a unique code that is valid for a finite, specific amount of time and for a specific amount of funds of the corresponding payment card account. The unique code is sent to the user at operation 225. This unique code is strictly tied to the user's payment card account and can be used to authorize future purchase transactions so long as the transactions are within the time and amount constraints defining the unique code.

In some embodiments, the user may specify the time limit and amount to associate with the purchase pre-authorization unique code. There may be some constraints on the period of time and/or amount of authorized funds granted with the unique code. The constraints may be defined by an issuer of the payment card account, the purchase pre-authorization service, system, or application (or a servicer thereof), and the user. For example, the purchase pre-authorization service, system, and application may limit the length of time for a purchase pre-authorization code to be valid to one (1) week or some other period of time. In this scenario, a user may request a new purchase pre-authorization after the expiration of a first purchase pre-authorization code. Likewise, limits for the amount of funds authorized by the purchase pre-authorization code can be set by the issuer of the payment card account, the purchase pre-authorization service, system, or application (or a servicer thereof), and the user. In some embodiments, the user may have to specify at least one of the time period and amount of funds for the purchase pre-authorization code. In some other embodiments, the user might not be able to specify or request at least one of the time period and amount of funds for the purchase pre-authorization code

Operation 230 includes the user presenting the unique code to a merchant for use in determining the authorization of a purchase transaction with the merchant. In some instances, the unique code may substitute for other processing determinations for an authorization approval code for the purchase transaction. In yet some other embodiments, the unique code may be used in determining the authorization approval code for the purchase transaction.

In some aspects, some of the processes disclosed herein may use a separate precheck authorization rail and database (as compared to, for example, a conventional authorization process) and may confer a number of benefits. For example, aspects of the processes and systems disclosed herein to implement the processes might act as an expedited priority line, making a transaction process faster. In another aspect, using a purchase pre-authorization channel and precheck database as disclosed herein, may provide a mechanism and/or opportunity for a merchant to identify (e.g., flag) a customer (e.g., a highly motivated customer), and at time of a pre-authorization, make a real time offer of one or more incentives or program perks (e.g., free shipping or 5% off) to the customer. In this manner, participating merchants might be able to influence where the customer uses their pre-authorization, as well as providing a tangible benefit to the customer.

Process 200 provides a mechanism for a user to request and receive a purchase pre-authorization that can be used in a future one or more purchase transactions. A merchant can be assured of the approval of a purchase transaction when the consumer user presents a unique code in accordance with the processes disclosed herein, given the unique code is valid (i.e., no expiration of the time or exceeded limit of funds).

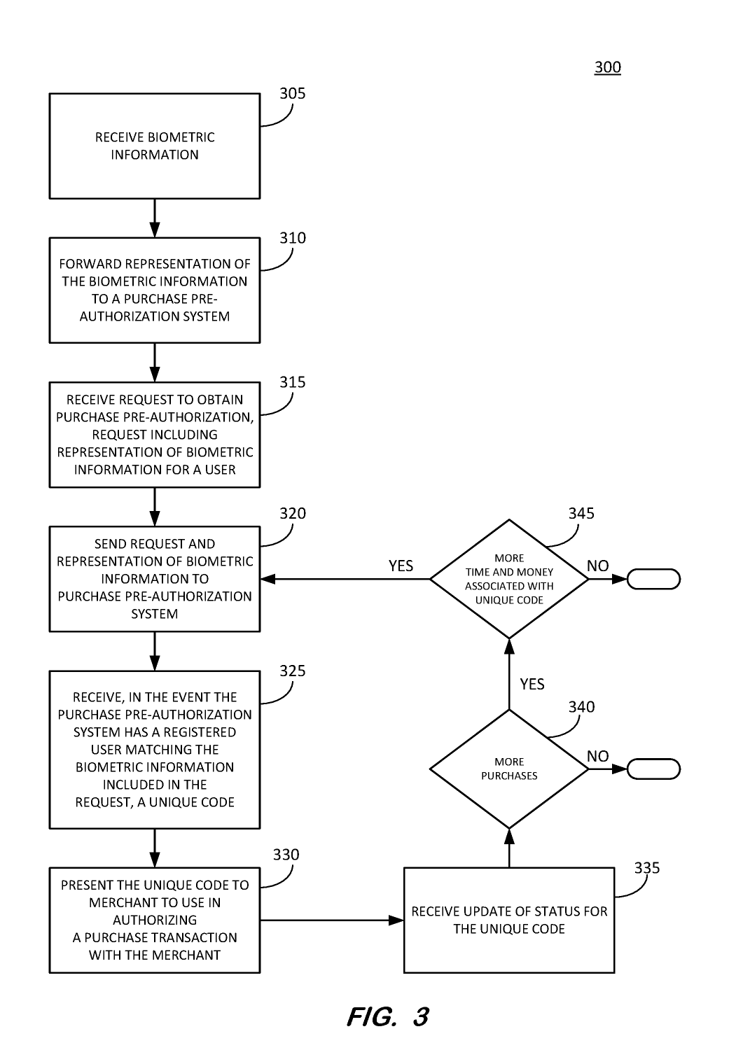

FIG. 3 is an illustrative flow diagram of a process, in accordance with an example embodiment herein. Process 300 may be a seen as flow from the perspective of a mobile device executing an application or functionality including some aspects of a purchase pre-authorization herein. Process 300 may include a plurality of operations beginning before a user starts a purchase transaction with a merchant for goods and/or services. At operation 305, biometric information is received by a consumer mobile device of a user. The biometric information may be at least one of the following types of biometric data: a fingerprint, an iris scan, a retina scan, a voice scan, a face scan, other biometric features, and combinations thereof.

At operation 310, the mobile device forwards a representation of the biometric information of the user to a purchase pre-authorization service, server, application, or system. Independent of the mobile device, the purchase pre-authorization service, server, application, or system may operate to register the user that supplied the biometric information at operation 305 with the purchase pre-authorization service, server, application, or system.

Regarding operation 315, a request to obtain a purchase pre-authorization code is received by the mobile device from the user. The request may include biometric information from the user and may be received via the biometric or other (e.g., camera) sensors of the mobile device. The request may be received from the user in response to the user determining they will be, for example, shopping for presents over the next two days.

At operation 320, a request for a purchase pre-authorization code is sent to the purchase pre-authorization service, server, application, or system by the mobile device. The request may include a representation of the biometric information received at operation 315. Independent of the mobile device, the purchase pre-authorization service, server, application, or system determines whether the biometric information sent at operation 320 matches a payment card account thereof. In the event there is a match, then a purchase pre-authorization code is generated by the purchase pre-authorization service, server, application, or system and sent to the mobile device. The purchase pre-authorization code is received by the mobile device at operation 325.

Continuing to operation 330, the unique code can be displayed on the display of the mobile device and the user can present the unique code to a merchant to use to authorize a purchase transaction. The authorization for the purchase transaction should occur within the timeframe and spending amount limits associated with the unique code. For example, if the code is valid for the next 48 hours and includes a spending limit of $1500, then one or more purchase transactions should be approved if an authorization for all of the one or more transactions is performed within the prescribed 48 hours and the total for the one or more transactions is less than or equal to the $1500 limit.

Process 300 further includes an update of the status of the unique code being provided to the mobile device at operation 335. At operation 335, the user may receive a message that the unique code will be valid for 24 more hours and now has $500 spending limit (e.g., $1000 out of $1500 was spent in the first 24 hours on authorized purchased transactions).

Process 300 also contemplates more than one purchase transaction using the purchase preauthorization unique code at operation 340. If more purchases are to be made using the unique code, then the process advances to operation 345. If no more purchases using the unique code, then the flow 300 can terminate. At operation 345, a determination is made whether the unique code is still valid. That is, is there any more remaining time and funds associated with the unique code. If not, then process 300 can terminate, otherwise flow returns to operation 320 for the authorization of additional purchase transactions.

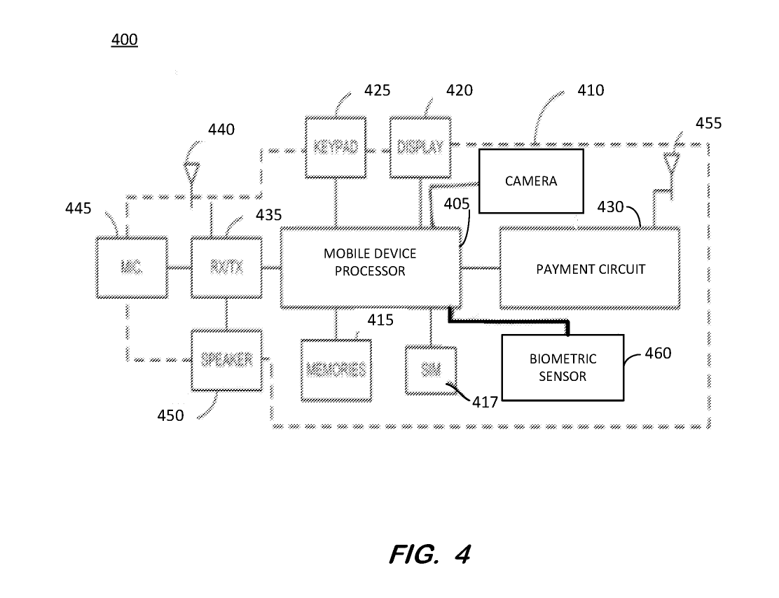

FIG. 4 illustrates a mobile device 400 in accordance with an exemplary embodiment. For example, mobile device 400 may be a mobile phone (such as a Smartphone), a tablet computer, a laptop computer, a phablet, a smart watch, an internet appliance, and the like, and may contain convention hardware components. Mobile device 400 may include a conventional housing (indicated by the dashed line 410) that contains and/or supports the components of the mobile device 400. The housing 410 may be shaped and sized to be held in a user's hand, and may for example fit in the palm of the user's hand. In some embodiments, housing 410 may have a different form factor (e.g., as a tablet computer, mini-tablet computer, or the like).

Mobile device 400 may include a mobile device processor 405 for controlling the over-all operation of the mobile device 400. For example, the mobile device processor 405 may include one or more processing devices, for example, a multicore processor, a reconfigurable multicore processor, and/or the like. Other components of the mobile device 400, which are in communication with and/or controlled by the mobile device processor 405, include memory devices 415 (e.g., program and working memory and the like); a subscriber identification module (SIM) card 417; a keypad 425 for receiving user input; and a display component 420 (which may include a display screen and/or touch screen for displaying output information to, and receiving input information from, the user or cardholder). Thus, in some embodiments keypad 425 may be a conventional 12-key telephone keypad, and may include additional buttons, switches and/or keys (such as a conventional rocker-switch and/or select keys, soft keys, and send and/or end keys). In some other implementations, such as for a Smartphone, keypad 425 represents a digital keypad provided on a touch screen display 420 of mobile device 400.

Mobile device 400 may also include receive/transmit circuitry 435 that is in communication with and/or controlled by the control circuitry 405. The receive/transmit circuitry 435 is coupled to antenna 440 and may provide the communication channel(s) by which the mobile device 400 communicates via one or more communications networks (not shown). The receive/transmit circuitry 435 may operate both to receive and transmit voice signals, in addition to performing data communication functions, such as GPRS (general packet radio service) communications. For example, receive/transmit circuitry 435 may connect the mobile device 400 to a network such as the Internet, a cellular network, and the like. Accordingly, a user of mobile device 400 may control the mobile device to, for example, navigate to merchant websites on the World Wide Web, download mobile applications, and the like.

Mobile device 400 may further include a microphone 445, coupled to the receive/transmit circuitry 435. The microphone 445 may receive voice input from the user of the mobile device 400. In addition, a loudspeaker 450 is included to provide sound output to the user, and is coupled to the receive/transmit circuitry 435. In this example, the receive/transmit circuitry 435 may transmit, via the antenna 440, voice signals generated by the microphone 445, and reproduce, via the loudspeaker 450, voice signals received via the antenna 440. The receive/transmit circuitry 435 may also handle transmission and reception of text messages, video streams, mobile applications, and other data communications via the antenna 440.

The mobile device 400 may also include a payment circuit 430 and a loop antenna 455, coupled to the payment circuit 430. The payment circuit 430 may include functionality that allows the mobile device 400 to function as a contactless payment device. In some embodiments, the payment circuit 455 includes a processor (not separately shown) and a memory (not separately shown) that is coupled to the processor and stores program instructions for controlling the processor. Although shown as separate from the mobile device processor 405, the payment circuit 430 and/or its processor component(s) may be integrated with the mobile device processor 405. In accordance with some embodiments, the mobile device 400 may include a secure element (not separately shown), which may be incorporated into the payment circuit 430, the memories 415, the mobile device processor 405, the SIM card 417, and/or the like. As is familiar to those skilled in the art, the secure element may be constituted with a microprocessor and volatile and/or nonvolatile memory that are secured from tampering and/or reprogramming by suitable measures. The secure element may, for example, manage functions such as storing and reading out a payment card account number, and cryptographic processing.

The mobile telephone 400 may also include one or more biometric sensors 460 and an integrated digital camera 410, which can be configured to perform various functions, including obtain cardholder authentication data. For example, the digital camera 410 may be operably connected to the mobile device processor 405 and configured for taking pictures, and may also be utilized to read two-dimensional (2D) barcodes to obtain information, and/or may also be used to take a picture of the user's face for use by an authentication application that may concern facial recognition. The biometric sensors 460 may include one or more of a fingerprint sensor and/or a biochemical sensor and/or a motion sensor. For example, a motion sensor may be operable to generate motion data, for example, that can be utilized by the mobile device processor 405 to authenticate a user by, for example, identifying the user's walking style or gait. In another example, the biometric sensor may be fingerprint sensor that includes a touch pad or other component (not shown) for use by the user to touch or swipe his or her index (or other) finger when fingerprint data is required to authenticate the user. A biochemical sensor may include one or more components and/or sensors operable to obtain user biological data, such as breath data from the user, and/or other types of biological data which may be associated with the user of the mobile device 400. The data obtained by the biometric sensor(s) may be compared to biometric data and/or information of the user stored, for example, in the memories 415 in order to authenticate the user of the mobile telephone 400. Mobile device 400 may also contain one or more other types of sensors, such as an iris scanner device (not shown) for generating iris scan data of a user's eye, which may be useful for identifying biometric or other personal data of the mobile device user.

Apparatus 500 may be a representative implementation of server 115 in FIG. 1. Apparatus 500 includes processor 505 operatively coupled to communication device 515, data storage device 530, one or more input devices 510, one or more output devices 520, and memory 525. Communication device 515 may facilitate communication with external devices, such as a reporting client, or a data storage device. Input device(s) 510 may comprise, for example, a keyboard, a keypad, a mouse or other pointing device, a microphone, knob or a switch, an infra-red (IR) port, a docking station, and/or a touch screen. Input device(s) 510 may be used, for example, to enter information into apparatus 500. Output device(s) 520 may comprise, for example, a display (e.g., a display screen) a speaker, and/or a printer.

Data storage device 530 may comprise any appropriate persistent storage device, including combinations of magnetic storage devices (e.g., magnetic tape, hard disk drives and flash memory), optical storage devices, Read Only Memory (ROM) devices, etc., while memory 525 may comprise Random Access Memory (RAM), Storage Class Memory (SCM) or any other fast-access memory.

Services 535 and application 540 may comprise program instructions executed by processor 505 to cause apparatus 500 to perform any one or more of the processes described herein (e.g., 200, 300). Embodiments are not limited to execution of these processes by a single apparatus.

Data 545 (either cached or a full database) may be stored in volatile memory such as memory 525. Data storage device 530 may also store data and other program code and instructions for providing additional functionality and/or which are necessary for operation of apparatus 500, such as device drivers, operating system files, etc.

The foregoing diagrams represent logical architectures for describing processes according to some embodiments, and actual implementations may include more or different components arranged in other manners. Other topologies may be used in conjunction with other embodiments. Moreover, each component or device described herein may be implemented by any number of devices in communication via any number of other public and/or private networks. Two or more of such computing devices may be located remote from one another and may communicate with one another via any known manner of network(s) and/or a dedicated connection. Each component or device may comprise any number of hardware and/or software elements suitable to provide the functions described herein as well as any other functions. For example, any computing device used in an implementation of a system according to some embodiments may include a processor to execute program code such that the computing device operates as described herein.

The above descriptions and illustrations of processes herein should not be considered to imply a fixed order for performing the process steps. Rather, the process steps may be performed in any order that is practicable, including simultaneous performance of at least some steps. In addition, one or more of the steps may not be required for performance in some embodiments.

The present invention has been described herein in connection with specific exemplary embodiments, but it should be understood that various changes, modifications, substitutions, and/or alterations which may be apparent to those skilled in the art can be made without departing from the spirit and scope of the invention as set forth in the appended claims.

What is claimed is:

1. A method of operating a mobile device to effectuate an online purchase transaction, the method comprising:
receiving, by a processor of a consumer mobile device, a request from a user for a purchase pre-authorization;
receiving, by a biometric input component of the consumer mobile device, biometric data that uniquely identifies the user;
sending a representation of the biometric data to a pre-purchase authentication server;
receiving, by the mobile device processor from the pre-purchase server, a message including a unique code, the unique code being associated with a payment card account of the user and valid to use to authorize a future purchase transaction using the payment card account for a finite period of time and a specific amount of funds of the payment card account; and
displaying, on a display screen component of the consumer mobile device in response to the request, the unique code.

2. The method of claim 1, wherein the biometrics data relates to at least one of a fingerprint, an iris, a face, a retina, and a voice input of the user.

3. The method of claim 1, wherein the representation of the biometric data excludes information identifying the user.

4. The method of claim 1, wherein the request is initiated by the execution of an application on the mobile device.

5. The method of claim 1, wherein the message includes at least one of a text message, a short message service message, an email, and a message of a social network service.

6. The method of claim 1, wherein the unique code is associated with the payment card account of the user and is valid to use to authorize a plurality of different future purchase transactions using the payment card account for the finite period of time and the specific amount of funds of the payment card account.

7. The method of claim 1, wherein the unique code is displayed in at least one of a machine readable format and human readable format.

8. The method of claim 7, wherein the unique code is displayed on the display screen in the machine readable format and the display screen is presented to a machine to have the unique code read by the machine.

9. A system comprising:
a memory storing processor-executable instructions; and
a processor to execute the processor-executable instructions to cause the system to:
receive a request from a user for a purchase pre-authorization;
receive, by a biometric input component, biometric data that uniquely identifies the user;
send a representation of the biometric data to a pre-purchase authentication server;
receive from the pre-purchase server, a message including a unique code, the unique code being associated with a payment card account of the user and valid to use to authorize a future purchase transaction using the payment card account for a finite period of time and a specific amount of funds of the payment card account; and
display, on a display screen component in response to the request, the unique code.

10. The system of claim 9, wherein the biometrics data relates to at least one of a fingerprint, an iris, a face, a retina, and a voice input of the user.

11. The system of claim 9, wherein the representation of the biometric data excludes information identifying the user.

12. The system of claim 9, wherein the request is initiated by the execution of an application on a mobile device.

13. The system of claim 9, wherein the message includes at least one of a text message, a short message service message, an email, and a message of a social network service.

14. The system of claim 9, wherein the unique code is associated with the payment card account of the user and is valid to use to authorize a plurality of different future purchase transactions using the payment card account for the finite period of time and the specific amount of funds of the payment card account.

15. The system of claim 9, wherein the unique code is displayed in at least one of a machine readable format and human readable format.

16. The system of claim 7, wherein the unique code is displayed on the display screen in the machine readable format and the display screen is presented to a machine to have the unique code read by the machine.
